(19) United States
(12) Patent Application Publication
(10) Pub. No.: US 2014/0214699 A1
(43) Pub. Date: Jul. 31, 2014

(54) MANAGING INTELLECTUAL PROPERTY ASSET TRANSACTION INFORMATION IN A NETWORKED COMPUTING ENVIRONMENT

(71) Applicant: WISDOMAIN INC., Gyeonggi-do (KR)

(72) Inventors: Ilsoo Kim, Gyeonggi-do (KR); Seungho Jung, Gyeonggi-do (KR)

(73) Assignee: WISDOMAIN INC., Gyeonggi-do (KR)

(21) Appl. No.: 13/749,970

(22) Filed: Jan. 25, 2013

(51) Int. Cl. G06Q 50/18

(52) U.S. Cl. CPC G06Q 50/184
USPC 705/310

(57) ABSTRACT

A set of computer storage devices containing transaction records having transaction information corresponding to a set of transactions for a set of IP assets will be queried. At least a subset of the transaction information will be extracted and the types of IP transactions will be determined. A first table will then be generated based on the extracted transaction information. The first table typically identifies each IP transaction and corresponding transaction information. Based on the transaction information, a most recent transaction record for each of the set of IP assets will be identified. The system will then generate a second table based on the transaction information and the types of IP transaction(s). The second table will identify the most recent transaction information for each of the set of IP assets.

### TECHNICAL FIELD

Aspects of the present invention relate to information management. Specifically, the present invention relates to the management (e.g., retrieval and/or organization) of intellectual property (IP) asset transaction information in a networked computing environment.

### BACKGROUND

As business competition has become more global, the capability to view technological trends of a specific industry (or to analyze technological competitiveness) has become highly critical. One manner of determining industry trends and/or competiveness is to view various online references such as patent documents. Specifically, intellectual property (IP) documents (e.g., issued patents and/or published patent applications) are good indicators of industry trends and the directions in which competitors are shaping their product lines.

Many companies transfer IP assets such as patents as part of their corporate strategy. For example, some companies purchase patents to enter their target markets quickly while some purchase patents to generate licensing revenue. Alternatively, some companies sell their core patents to overcome financial obstacles, while some companies sell patents that no longer support their corporate strategy. There is currently no efficient way to determine all the patents transferred in a specific technology sector, or to know the parties involved in such transfers of ownership.

These issues are complicated given a growing trend to mortgage IP assets such as patents. Specifically, many of today's technology companies' more valuable assets are contained in their IP portfolios. As such, financing, etc., can be obtained by leveraging such assets. Similar to assigned IP assets, there is currently no efficient way to determine all the patents that have been mortgaged or in a specific technology sector, or to know the parties involved in the mortgage transactions.

### SUMMARY

In general, embodiments of the present invention provide an approach for managing transactional information for IP assets in a networked computing environment. In a typical embodiment, a set of computer storage devices containing transaction records having transaction information corresponding to a set of transactions (e.g., assignments, licenses, mortgages, etc.) for a set of IP assets will be queried (e.g., by keywords, identifiers, technology area, classification, etc.). At least a subset of the transaction information will be extracted, and types of IP transactions will be determined. A first table will then be generated based on the extracted transaction information. The first table typically identifies (among other things) each IP transaction and corresponding transaction information. Based on the transaction information, a most recent transaction record for each of the set of IP assets will be identified. The system will then generate a second table based on the transaction information and the types of IP transaction(s). The second table will identify (among other things) the most recent transaction information for each of the set of IP assets. Among other things, the system described herein may generate additional tables of information such as a third table that identifies an IP asset identifier (e.g., patent number, publication number, application number, registration number, etc.) and a current owner for each of the set of IP assets, and/or a fourth table that identifies an IP asset identifier and mortgage information corresponding to each identified mortgage involved in the IP assets.

A first aspect of the present invention provides a computer-implemented method for managing transaction information for intellectual property (IP) assets in a networked computing environment, comprising: querying a set of computer storage devices containing transaction records having transaction information corresponding to a set of transactions for a set of IP assets; extracting at least a subset of the transaction information; determining types of the set of IP transactions; generating a first table based on the extracted transaction information, the first table identifying the set of IP transactions and corresponding transaction information; identifying a most recent transaction record for each of the set of (IP) assets; and generating a second table based on the transaction information and the types of the set of IP transactions, the second table identifying most recent transaction information for each of the set of IP assets.

A second aspect of the present invention provides a system for managing transaction information for intellectual property (IP) assets in a networked computing environment, comprising: a memory medium comprising instructions; a bus coupled to the memory medium; and a processor coupled to the bus that when executing the instructions causes the system to: query a set of computer storage devices containing transaction records having transaction information corresponding to a set of transactions for a set of IP assets; extract at least a subset of the transaction information; determine types of the set of IP transactions; generate a first table based on the extracted transaction information, the first table identifying the set of IP transactions and corresponding transaction information; identify a most recent transaction record for each of the set of (IP) assets; and generate a second table based on the transaction information and the types of the set of IP transactions, the second table identifying most recent transaction information for each of the set of IP assets.

A third aspect of the present invention provides a computer program product for managing transaction information for intellectual property (IP) assets in a networked computing environment, the computer program product comprising a computer readable storage media, and program instructions stored on the computer readable storage media, to: query a set of computer storage devices containing transaction records having transaction information corresponding to a set of transactions for a set of IP assets; extract at least a subset of the transaction information; determine types of the set of IP transactions; generate a first table based on the extracted transaction information, the first table identifying the set of IP transactions and corresponding transaction information; identify a most recent transaction record for each of the set of (IP) assets; and generate a second table based on the transaction information and the types of the set of IP transactions, the second table identifying most recent transaction information for each of the set of IP assets.

A fourth aspect of the present invention provides a method for deploying a system for managing transaction information for intellectual property (IP) assets in a networked computing environment, comprising: providing a computer infrastructure being operable to: query a set of computer storage devices containing transaction records having transaction information corresponding to a set of transactions for a set of IP assets; extract at least a subset of the transaction information; determine types of the set of IP transactions; generate a first table based on the extracted transaction information, the first table identifying the set of IP transactions and corresponding transaction information; identify a most recent transaction record for each of the set of (IP) assets; and generate a second table based on the transaction information and the types of the set of IP transactions, the second table identifying most recent transaction information for each of the set of IP assets.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a more detailed system diagram according to an embodiment of the present invention.

FIG. 3 depicts a method flow diagram according to an embodiment of the present invention.

FIG. 4 depicts a table according to an embodiment of the present invention.

FIG. 5 depicts another table according to an embodiment of the present invention.

FIG. 6 depicts a method flow diagram according to an embodiment of the present invention.

FIG. 7 depicts another table according to an embodiment of the present invention.

FIG. 8 depicts a method flow diagram according to an embodiment of the present invention.

FIG. 9 depicts another table according to an embodiment of the present invention.

FIG. 10 depicts a system flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide an approach for managing transactional information for IP assets in a networked computing environment. In a typical embodiment, a set of computer storage devices containing transaction records having transaction information corresponding to a set of transactions (e.g., assignments, licenses, mortgages, etc.) for a set of IP assets will be queried (e.g., by keywords, identifiers, technology area, classification, etc.). At least a subset of the transaction information will be extracted and types of IP transactions will be determined. A first table will then be generated based on the extracted transaction information. The first table typically identifies (among other things) each IP transaction and corresponding transaction information. Based on the transaction information, a most recent transaction record for each of the set of IP assets will be identified. The system will then generating a second table based on the transaction information and the types of IP transaction(s). The second table will identify (among other things) the most recent transaction information for each of the set of IP assets. Among other things, the system described herein may generate additional tables of information such as a third table that identifies an IP asset identifier (e.g., patent number, publication number, application number, registration number, etc.) and a current owner for each of the set of IP assets, and/or a fourth table that identifies an IP asset identifier and mortgage information corresponding to each identified mortgage involved in the IP assets.

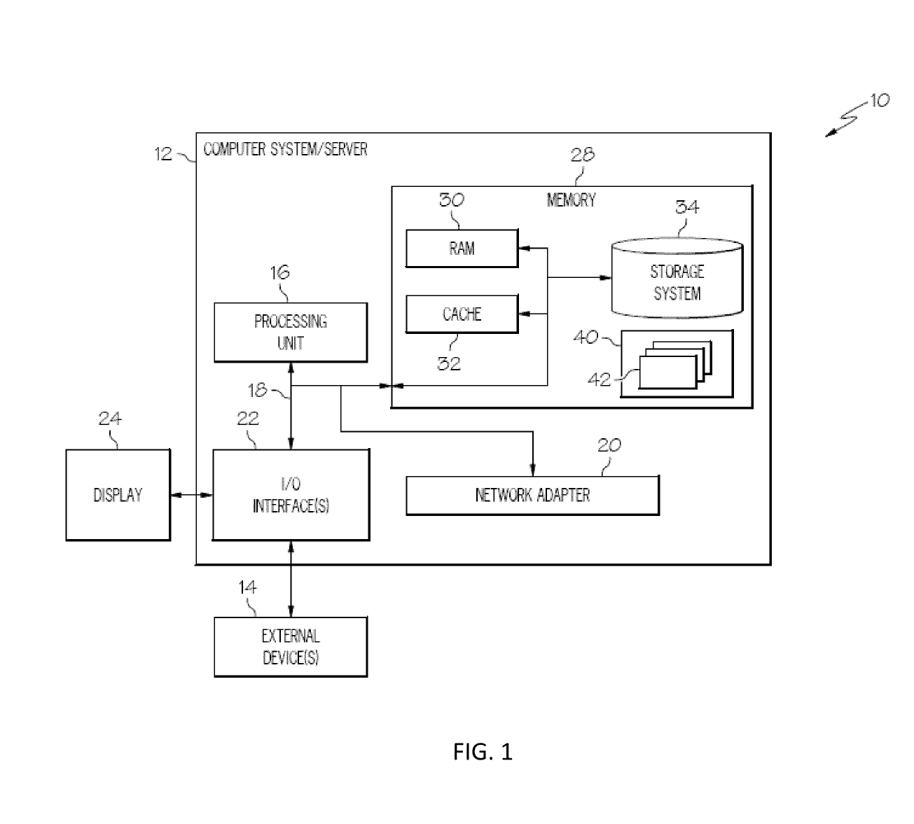

It is understood in advance that although the examples discussed herein and described in FIGS. 1-10 relate to patents, similar teachings could be applied to any type of IP asset such a trademarks, copyrights, trade secrets, know-how, show-how, etc. Moreover, although some of the examples discussed herein (e.g., shown in the various flow diagrams and/or tables of the Figs.) relate to patent assignments, similar teachings could be applied to other transaction types (e.g., licenses, mortgages, etc.).

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin potential clients, thick potential clients, hand-held or laptop devices, mobile devices, global positioning systems (GPS), GPS-enabled devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each such media component can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. In general, program/utility 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

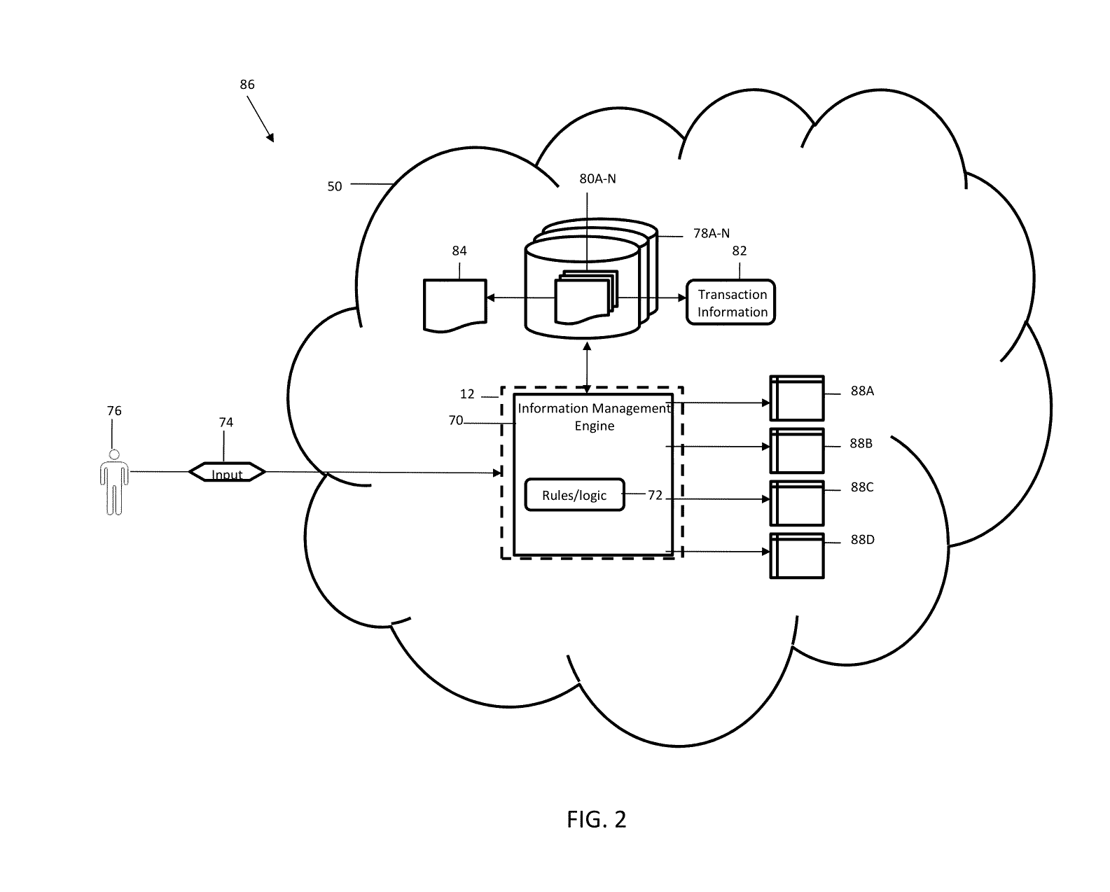

Referring now to FIG. 2, a system diagram describing the functionality discussed herein according to an embodiment of the present invention is shown. It is understood that the teachings recited herein may be practiced within any type of networked computing environment 86 (e.g., a cloud computing environment 50). A computer system/server 12, which can be implemented as either a stand-alone computer system or as a networked computer system is shown. In the event the teachings recited herein are practiced in a networked computing environment 86, each client need not have an information management engine (engine 70). Rather, engine 70 could be loaded on a server or server-capable device that communicates (e.g., wirelessly) with the clients to provide information management functionality. Regardless, as depicted, engine 70 is shown within computer system/server 12. In general, engine 70 can be implemented as program/utility 40 on computer system 12 of FIG. 1 and can enable the functions recited herein. As further shown, engine 70 (in one embodiment) comprises a rules and/or computational engine that processes a set (at least one) of rules/logic 72 and/or provides information management hereunder.

Along these lines, engine 70 may perform multiple functions similar to a general-purpose computer. Specifically, among other functions, engine 70 may (among other things): query (e.g., based upon a set of keywords, a set of IP asset identifiers, or a set of transaction type indicators received as search input 74 from user 76) a set of computer storage devices 78A-N containing transaction records 80A-N having transaction information 82 corresponding to a set of transactions for a set of IP assets (a patent, a trademark, or a copyright); extract at least a subset of the transaction information 82; determine types of the set of IP transactions; generate a first table 88A based on the extracted transaction information 82, the first table identifying the set of IP transactions and corresponding transaction information 82; identify a most recent transaction record 84 for each of the set of (IP) assets; generate a second table 88B based on the transaction information 82 and the types of the set of IP transactions (e.g., an assignment transaction, a licensing transaction, or a mortgage transaction), the second table 88B identifying the most recent transaction information for each of the set of IP assets; generate a third table 88C based on the transaction information 82, the third table 88C identifying an IP asset identifier and a current owner for each of the set of IP assets; determine whether a particular IP transaction comprises an assignment of any of the set of IP assets; determine whether the set of IP transaction records 80A-N identify any mortgages of any of the set of IP assets; generate a fourth table 88D based on the identified mortgages, the fourth table 88D identifying an IP asset identifier and mortgage information corresponding to each identified mortgage.

As indicated above, IP assets can be assigned, mortgaged, licensed, etc., pursuant to one or more IP transactions for various reasons. Such information is typically contained in a variety of different databases (e.g., in different formats) having different querying/searching conventions. For example, in the current patent assignment database, an “assignee” field search does not support searching the most recent assignment record only. Consequently, it is hard to know who the most recent owner (current assignee) is (or the most recent mortgagee for a mortgage) as of the searching date until the searcher reads all the search results one by one.

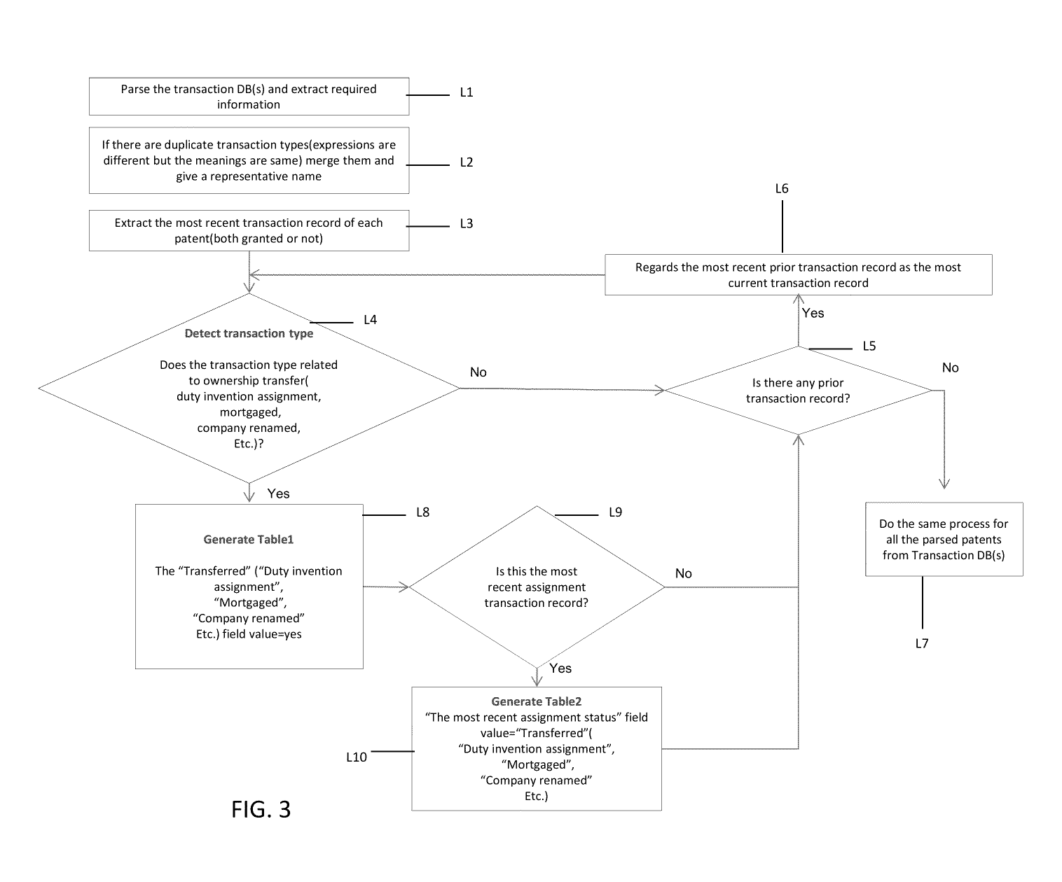

The approach/system described herein allows such information to be gathered and organized across fields of technology, owners, etc. As such, various processes are provided hereunder. One such process implemented by engine 70 is shown in FIG. 3. As depicted, in step L1 various transaction databases will be parsed. Such databases may include any collection of databases now known or later developed that may contain IP asset transaction data. Examples include the USPTO assignment database, banking databases (e.g., for mortgage information), etc. In any event, in step L2, any duplicate transaction types/records will be merged and given a representative name. In step L3, the most recent transaction record will be extracted for each patent (or other IP asset). In step L4, it will be determined whether the conveyance type relates to ownership transfer and/or leveraging. If not, it will be determined whether there are any prior transaction records in step L5. If so, whatever record is most recent will be regarded as the most “current” in step L6 and the process returns to step L4. If there are no prior transaction records in step L5, the same process will be repeated for all transaction databases in step L7 to ensure that that the most recent transaction records are being utilized. If the conveyance type did relate to ownership transfer and or leveraging in step L4, the first table/table1 (88A) will be generated in step L8, and in step L9, it will be determined whether the most recent transaction record is being utilized. If not, the process returns to step L5 (iteratively). If so, the second table/table2 (88B) will be generated in step L10 (e.g., with field values set as described in step L10).

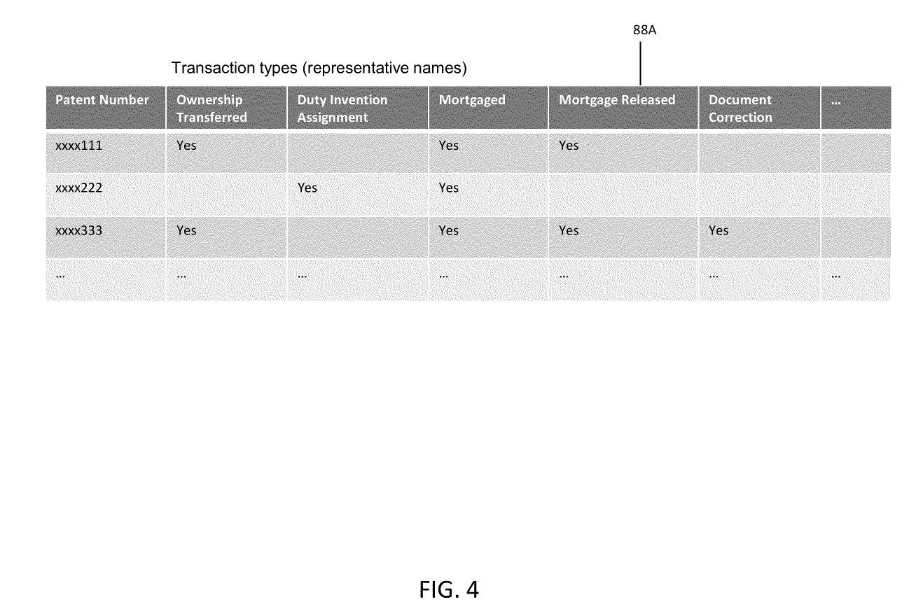

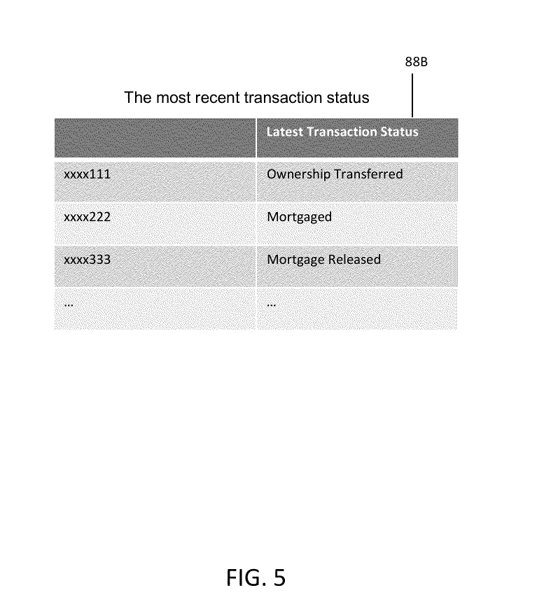

Examples of tables 88A-B are shown in FIGS. 4-5 respectively. Referring first to FIG. 4, table 88A is shown. As described above, the collection of databases may be queried to produce tables such as table 88A. Engine 70, among other things, allows querying based upon any type of search string on any number of fields in the records stored in the databases. For example:
“PATENTABSTRACT=cloud and OWNERSHIPTRANSFERRED=yes” may be utilized as search input to retrieve ownership transferred patents that have “cloud” term in the abstract field.
“CURRENTASSIGNEE=AAA not ORIGINALASSIGNEE=AAA” may be utilized to retrieve the patents that are purchased by company “AAA.”
“ORIGINALASSIGNEE=BBB and OWNERSHIPTRANSFERRED=yes” to retrieve the patents that are sold by company “BBB.”
“PATENTCLAIMS=cloud and CURRENTLYMORTGAGED=yes” may be utilized to retrieve the patents that are currently mortgaged and have “cloud” terminology in claims.
   In any event, once any querying has been completed, tables such as table 88A may be generated by engine 70 to depict various segments of information in an organized fashion. As shown, table 88A has columns for IP asset identifiers (e.g., patent numbers), ownership transfer indicators, duty to assign indicators, mortgage indicators, mortgage release indicators, document correction indicators, etc. Table 88A thus provides a “snapshot” as to the various transactions that may be occurring with respect to particular IP assets. FIG. 5 shows table 88B, which is intended to provide a “most recent event” status for each IP asset returned from the query. As shown, columns in table 88B include IP asset identifiers and latest transaction status (e.g., transferred, mortgaged, etc.).

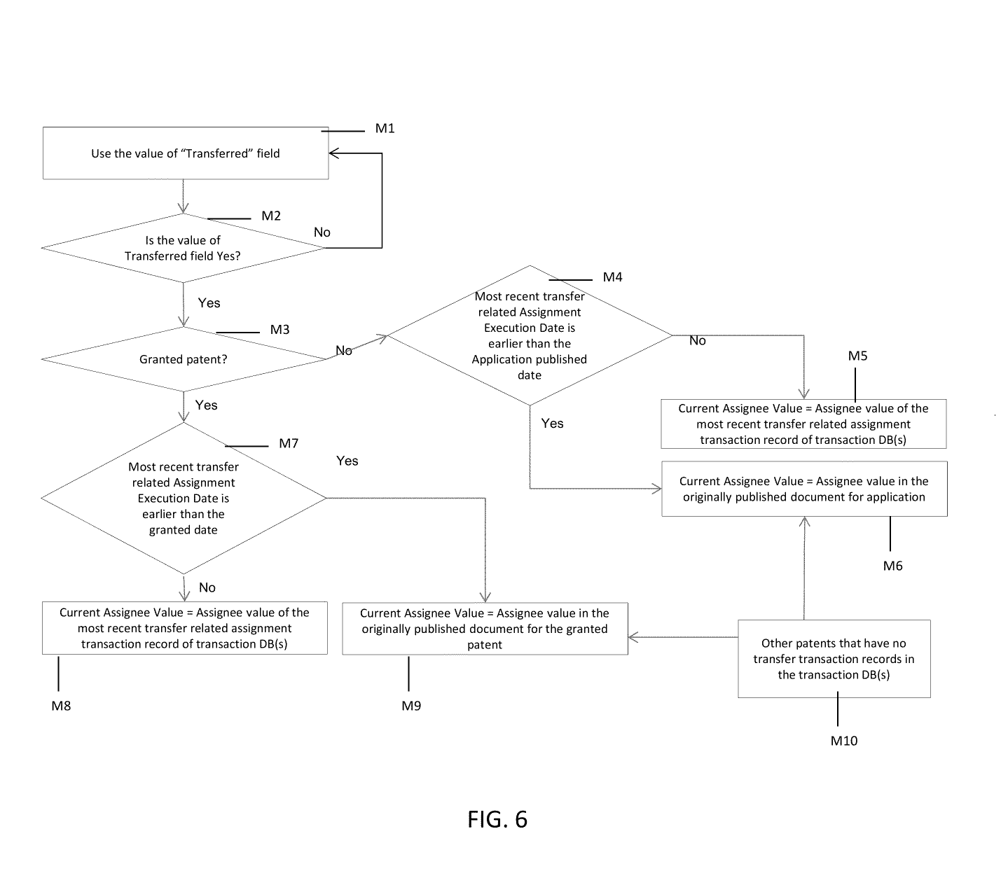

In addition, engine 70 has a way to determine the latest owner or assignee. As known, a patent may be transacted multiple times (e.g., assigned, leveraged/mortgaged, etc.). Determining the most recent status may greatly affect a patent's value and subsequent transferability. Referring now to FIG. 6, a flow diagram implemented by engine 70 to provide this functionality is shown. As shown in step M1, the value of a “transferred” field is used/examined. In step M2, it is determined whether the value of the field is “yes.” If not, the process may iterate. If so, it is determined whether the IP asset (e.g., patent) is a granted patent (versus a pending patent) in step M3. If not, it is determined whether the most recent transfer related assignment's execution date is earlier than the application's publication date in step M4. If so, the current assignee value is set equal to the assignee value of the most recent transfer related assignment transaction record in the database(s) in step M5, If not, the current assignee value is set equal to the assignee value in the originally published document for the pending application in step M6. In any event, if the IP asset is a granted patent in step M3, it is determined in step M7 whether the most recent transfer related assignment execution date is earlier than the granted date (i.e., was the patent assigned before the patent issued). If not, the current assignee value is set equal to the assignee value of the most recent transfer related assignment transaction record in the transaction database(s) in step M8. If so, the current assignee value is set equal to the assignee value in the originally published document for the granted patent in step M9. As further shown in FIG. 6, an asset/patent having no transfer transaction records may be handled via step M6 or step M9 depending on whether the patent is granted.

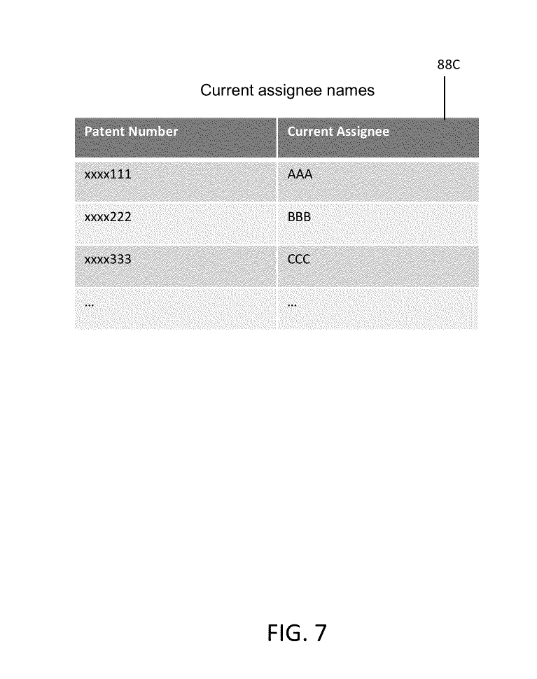

Referring now to FIG. 7, an example of a table 88C that may be generated by the process of FIG. 6 is shown. As depicted, table 88C includes columns for IP asset identifiers as well as current assignees. Table 88C allows a user to quickly ascertain the current owner of an IP Asset. Under previous approaches, such a determination required a user to manually parse the assignment or other databases and sort out the dates of assignments for each IP asset.

As further described above, mortgages represent a growing trend among IP assets. Specifically, a company seeking additional capital influx may choose to obtain financing using IP assets as collateral (as opposed to encumbering the assets via sale or licensing transactions). Engine 70 also provides a way to locate, parse, analyze, and organize (e.g., in a table) such mortgage information.

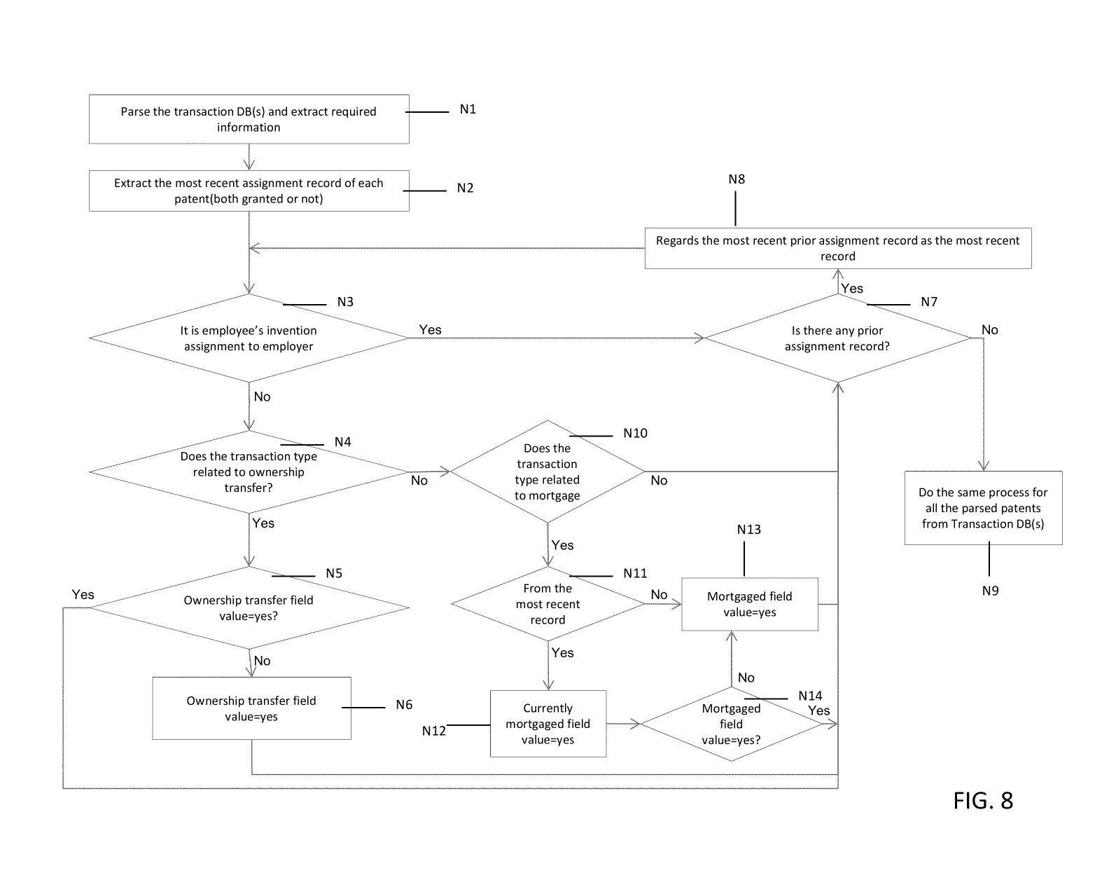

Referring now to FIG. 8, a method flow diagram implemented by engine 70 to provide this functionality is shown. In step N1, the transaction database(s) are parsed, and in step N2, the most recent assignment record of each patent (granted or pending) is extracted. In step N3, it is determined whether the patent relates to an invention that an employee is required to assign or license to an employer. If so, it is determined whether there is a previous assignment record in step N7. If not, the same process is performed for all patents parsed from the transaction db(s) in step N9. If so, engine 70 will regard the most recent prior assignment record as the most recent record in step N8, and the process will return to step N3. If the employee was not required to assign/license the invention to an employer in step N3, it is determined whether the conveyance/transaction type relates to ownership transfer in step N4. If so, it is determined if the ownership transfer field value is set equal to “yes” in step N5. If so, the process flows to step N7. If not, the ownership transfer field value is set equal to “yes” in step N6 before the process flows to step N7. If the conveyance type did not relate to ownership transfer in step N4, it is determined in step N10 whether the conveyance type relates to a mortgage of the patent. If not, the process flows to step N7. If so, it is determined whether the entry is from the most recent record in step N11. If not, the mortgage field value is set to “yes” in step N13 before the process flows to step N7. If the entry is from the most recent record in step N11, the currently mortgage field value is set to “yes” in step N12. Then, in step N14, it is determined if the mortgage field value is set equal to “yes”. If so, the process flows to step N7. If not, the value is set as such in step N13 before the process flows to step N7.

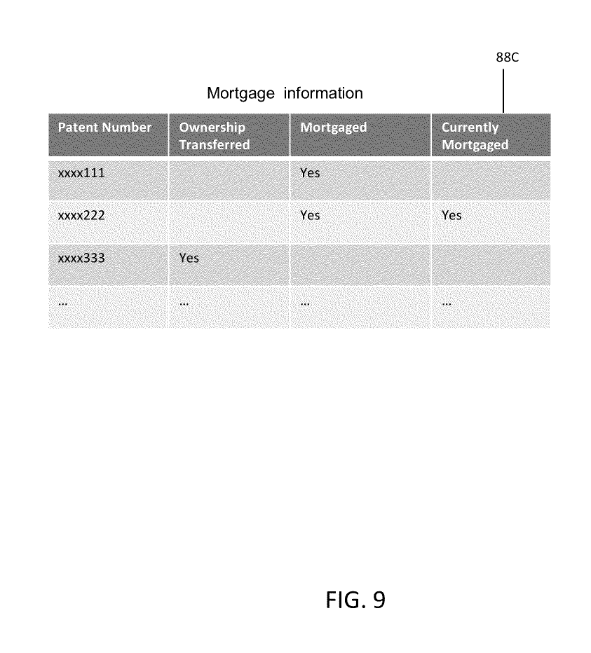

Referring to FIG. 9, a table 88D produced according to the method of FIG. 8 is shown. As depicted, table 88D shows transaction information across various transaction types. Table 88D includes columns for IP asset identifiers, ownership transfer indicators, mortgage indicators, and mortgage status indicators. Table 88D allows a current encumbrance of an IP asset to be readily ascertained.

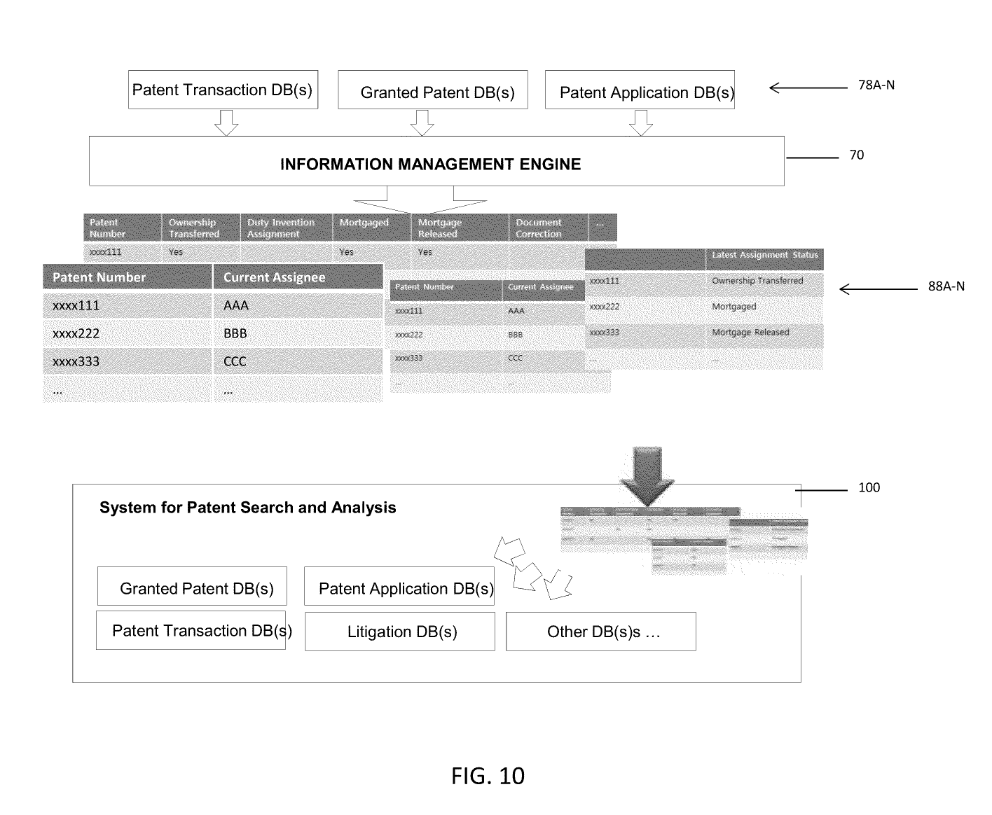

Referring to FIG. 10, the interaction of the system of the present invention with other related systems is shown. As depicted, databases 78A-N are accessed by engine 70 to generate tables 88A-N. These tables may be fed into a greater searching and analysis system 100 to provide support for other functions such as litigation support.

While shown and described herein as an information management system, it is understood that the invention further provides various alternative embodiments. For example, in one embodiment, the invention provides a computer-readable/useable medium that includes computer program code to enable a computer infrastructure to provide information management as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide information management functionality. In this case, the service provider can create, maintain, support, etc., a computer infrastructure, such as computer system/server 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method information management. In this case, a computer infrastructure, such as computer system 12/server (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for managing transaction information for intellectual property (IP) assets in a networked computing environment, comprising:
querying a set of computer storage devices containing transaction records having transaction information corresponding to a set of transactions for a set of IP assets;
extracting at least a subset of the transaction information;
determining types of the set of IP transactions;
generating a first table based on the extracted transaction information, the first table identifying the set of IP transactions and corresponding transaction information;
identifying a most recent transaction record for each of the set of (IP) assets; and
generating a second table based on the transaction information and the types of the set of IP transactions, the second table identifying most recent transaction information for each of the set of IP assets.

2. The computer-implemented method of claim 1, further comprising generating a third table based on the transaction information, the third table identifying an IP asset identifier and a current owner for each of the set of IP assets.

3. The computer-implemented method of claim 1, the determining comprising determining whether a particular IP transaction comprises an assignment of any of the set of IP assets.

4. The computer-implemented method of claim 1, the determining comprising determining whether the set of IP transaction records identifies any mortgages of any of the set of IP assets.

5. The computer-implemented method of claim 4, generating a fourth table based on the identified mortgages, the fourth table identifying an IP asset identifier and mortgage information corresponding to each identified mortgage.

6. The computer-implemented method of claim 1, the set of IP assets comprising at least one of the following: a patent, a trademark, or a copyright.

7. The computer-implemented method of claim 1, the types of IP transactions comprising at least one of the following: an assignment transaction, a licensing transaction, or a mortgage transaction.

8. The computer-implemented method of claim 1, the querying being based on search input, the search input comprising at least one of the following: a set of keywords, a set of IP asset identifiers, or a set of transaction type indicators.

9. A system for managing transaction information for intellectual property (IP) assets a networked computing environment, comprising:
a memory medium comprising instructions;
a bus coupled to the memory medium; and
a processor coupled to the bus that when executing the instructions causes the system to:
query a set of computer storage devices containing transaction records having transaction information corresponding to a set of transactions for a set of IP assets;
extract at least a subset of the transaction information;
determine types of the set of IP transactions;
generate a first table based on the extracted transaction information, the first table identifying the set of IP transactions and corresponding transaction information;
identify a most recent transaction record for each of the set of (IP) assets; and
generate a second table based on the transaction information and the types of the set of IP transactions, the second table identifying most recent transaction information for each of the set of IP assets.

10. The system of claim 8, the memory medium further comprising instructions to generate a third table based on the transaction information, the third table identifying an IP asset identifier and a current owner for each of the set of IP assets.

11. The system of claim 8, the memory medium further comprising instructions to determine whether a particular IP transaction comprises an assignment of any of the set of IP assets.

12. The system of claim 8, the memory medium further comprising instructions to determine whether the set of IP transaction records identifies any mortgages of any of the set of IP assets.

13. The system of claim 12, the memory medium further comprising instructions to generate a fourth table based on the identified mortgages, the fourth table identifying an IP asset identifier and mortgage information corresponding to each identified mortgage.

14. The system of claim 8, the set of IP assets comprising at least one of the following: a patent, a trademark, or a copyright.

15. The system of claim 8, the types of IP transactions comprising at least one of the following: an assignment transaction, a licensing transaction, or a mortgage transaction.

16. The system of claim 8, the query being based on search input, the search input comprising at least one of the following: a set of keywords, a set of IP asset identifiers, or a set of transaction type indicators.

17. A computer program product for managing transaction information for intellectual property (IP) assets in a networked computing environment, the computer program product comprising a computer readable storage media, and program instructions stored on the computer readable storage media, to:
query a set of computer storage devices containing transaction records having transaction information corresponding to a set of transactions for a set of IP assets;
extract at least a subset of the transaction information;
determine types of the set of IP transactions;
generate a first table based on the extracted transaction information, the first table identifying the set of IP transactions and corresponding transaction information;
identify a most recent transaction record for each of the set of (IP) assets; and
generate a second table based on the transaction information and the types of the set of IP transactions, the second table identifying most recent transaction information for each of the set of IP assets.

18. The computer program product of claim 17, further comprising program instructions stored on the computer readable storage media to generate a third table based on the transaction information, the third table identifying an IP asset identifier and a current owner for each of the set of IP assets.

19. The computer program product of claim 17, further comprising program instructions stored on the computer readable storage media to determine whether a particular IP transaction comprises an assignment of any of the set of IP assets.

20. The computer program product of claim 17, further comprising program instructions stored on the computer readable storage media to determine whether the set of IP transaction records identifies any mortgages of any of the set of IP assets.

21. The computer program product of claim 20, further comprising program instructions stored on the computer readable storage media to generate a fourth table based on the identified mortgages, the fourth table identifying an IP asset identifier and mortgage information corresponding to each identified mortgage.

22. The computer program product of claim 17, the set of IP assets comprising at least one of the following: a patent, a trademark, or a copyright.

23. The system of claim 17, the types of IP transactions comprising at least one of the following: an assignment transaction, a licensing transaction, or a mortgage transaction.

24. The system of claim 17, the query being based on search input, the search input comprising at least one of the following: a set of keywords, a set of IP asset identifiers, or a set of transaction type indicators.

25. A method for deploying a system for managing transaction information for intellectual property (IP) assets in a networked computing environment, comprising:
providing a computer infrastructure being operable to:
query a set of computer storage devices containing transaction records having transaction information corresponding to a set of transactions for a set of IP assets;
extract at least a subset of the transaction information;
determine types of the set of IP transactions;
generate a first table based on the extracted transaction information, the first table identifying the set of IP transactions and corresponding transaction information;
identify a most recent transaction record for each of the set of (IP) assets; and
generate a second table based on the transaction information and the types of the set of IP transactions, the second table identifying most recent transaction information for each of the set of IP assets.
